(19) United States
(12) Patent Application Publication
(10) Pub. No.: US 2012/0090593 A1
(43) Pub. Date: Apr. 19, 2012

(54) COOKING APPARATUS WITH A COOKING FUEL IGNITION FACILITATOR AND METHOD OF ASSEMBLING AND USING SAME

(75) Inventors: Brian Urquhart, Columbus, GA (US); Don McLemore, Fortson, GA (US)

(73) Assignee: Masterbuilt Manufacturing, Inc., Columbus, GA (US)

(21) Appl. No.: 13/276,773

(22) Filed: Oct. 19, 2011

Related U.S. Application Data
(60) Provisional application No. 61/394,598, filed on Oct. 19, 2010.

(51) Int. Cl. A47J 37/07; A47J 36/34; B23P 19/04; A47J 27/00

(52) U.S. Cl. 126/25 B; 126/1 R; 126/9 R; 431/6; 126/15 R; 29/428

(57) ABSTRACT

A cooking fuel ignition assembly for an outdoor cooking apparatus as in a barbeque grill. The ignition assembly includes a tinder support combination of an ash can and tinder support stand. An operator inserts the tinder support stand within the ash can such that its lower spacer structure makes contact with the base of the ash can receptacle and the upper tinder platform is in the upper region of the ash can. The operator places tinder T on the upper surface of the tinder platform. The tinder combination with tinder is mounted in suspended fashion below an aperture in the grill base such that upon ignition of the tinder a flame extends up through, for example, an interface slide catch collar assembly and into an ignition relationship with supported cooking fuel above.

### RELATED APPLICATIONS

This application claims priority under 35 U.S.C. §119(e) to U.S. Provisional Application Ser. No. 61/394,598, filed Oct. 19, 2010, which application is incorporated herein by reference.

### FIELD OF THE INVENTION EXAMPLE(S)

This invention relates to an outdoor cooking apparatus such as a charcoal fired barbecue grill with cooking fuel ignition facilitator assembly with a tinder source positioning assembly for use in, for example, rapid lighting of the barbeque briquettes in a barbeque grill.

### BACKGROUND

Barbeque grills are available in a wide variety of models and shapes for both closed and/or open barbeque cooking using charcoal to provide the source of heat. Typically, the grills of this type comprise a receptacle that defines a floor having one or more draft openings that may or may not be adjustable, a charcoal supporting grid that is removably mounted across the floor of the receptacle, and a cooking grid that is removably mounted in or on the receptacle in spaced relation above the charcoal supporting grid. Both grids are foraminous in nature, with each typically being formed from spaced rods or the like suitably bonded together in criss-cross relation, with the rods of the charcoal grid being spaced to support the charcoal (typically in the common briquette form) that is to cook the food, and the rods of the cooking grid being spaced to support the food to be cooked.

Charcoal is a slow burning material which is somewhat difficult to ignite. In order to ignite a chunk of charcoal it must be subjected to high temperature for a considerable period of time. It has generally been the practice to ignite the charcoal in one of the below described principal methods.

In the first, a base fire of paper and wood is laid and charcoal is placed upon it. The burning of the wood and paper causes the ignition of the charcoal. This is obviously a bother, for the fire is not only difficult to set up but also difficult to keep going unless considerable care is exercised in the initial laying of it.

In a second method, it has been common practice initially to spray the charcoal with a lighter fluid and to ignite that fluid. The burning of the fluid subjects the charcoal to flames which ignite the charcoal elements. This is a reasonably satisfactory method of igniting charcoal from an operational standpoint, but it can be extremely dangerous unless carefully performed. The most common hazard arises from the impatience of the operator who feels that his charcoal is not igniting fast enough or who failed to apply a sufficient amount of fluid to ignite the charcoal in the first instance. Many times that person has given the charcoal an extra squirt only to have the flame return to the supply container and ignite.

A third method of igniting the charcoal is to contact the charcoal for a period of time with a metallic element which has been electrically heated to a red glow. This element is somewhat safer than the use of fluid, but it is expensive, it requires a source of electricity, and it must have a safe place for its storage for it is red hot when it is taken from the ignited coals. It is not impossible for someone inadvertently to bump against the element and receive a serious burn.

A fourth method features charcoal starter devices that feature tube like, apertured bottomed container lighter devices designed for support on top of a charcoal grate of a grill and having a charcoal briquette chamber with an underlying paper receptacle. In this regard, reference is made to U.S. Pat. Nos. 2,920,614 (Phelps); 3,073,263 (Wynkoop) 3,453,975 (Gunter); 3,499,399 (Kaufmann); 3,865,052 (Streets et al.), 4,227,510 (Frazier et al.) showing various charcoal starter devices. As seen, many of such devices under this fourth method include the placement of paper and charcoal within a cylindrical can. The paper is ignited and burns around the charcoal. This method also has its problems for it is possible to smother the fire before it gets started by packing the paper too tightly in the can and covering it with too much charcoal. This method also often involves extensive hand manipulation in the region of hot coals as the operator spreads the coals and removes the container from its resting location on the charcoal grate during the set up for cooking.

A fifth method involves providing a hole in the bottom of the charcoal containing bowl, and hanging from the lower surface of the bowl below the hole a receptacle into which newspapers can be crumpled and ignited to cause a flame to contact charcoal supported above the hole. When the newspaper is ignited, the walls of the receptacle tend to form a short chimney which encourages the flow of air over the paper and the charcoal to speed the complete ignition of all the elements of charcoal.

Examples of this fifth method include U.S. Pat. No. 3,209,743 to Stewart et al. These devices have proven to not be completely satisfactorily as in regard to not sufficiently igniting the charcoal placed in the grill base by the time the supplied newspaper has been consumed.

Also known in the art are barbeque grills known as a “kettle-type” grill. The traditional kettle-type barbecue grill includes a generally semi-hemispherical bottom bowl that has a circular open top and cooking grid slightly below the upper rim of the bowl. A generally semi-hemispherical top cover can be placed on the bottom bowl to allow heat retention and/or smoking of food being cooked within. The bowl is generally supported on a tube-in-socket tripod leg arrangement.

Traditional barbecue kettle grills have been designed for burning charcoal as a heat source and have a second grid for supporting the charcoal below the cooking surface. Both the bowl and cover have vent openings to provide the necessary oxygen for combustion of the charcoal while the cover is closed. The vent openings in the bowl have traditionally been used for disposing of the ashes that accumulate in the bottom of the chamber.

### SUMMARY OF THE INVENTION

An embodiment of the present application includes an outdoor cooking apparatus with a cooking fuel ignition facilitator assembly with an example of an outdoor cooking apparatus being a charcoal fired grill, such as a kettle grill, with an incorporated charcoal briquette (or alternate fuel source) ignition facilitator assembly.

An embodiment includes an ignition facilitator assembly (e.g., one that is based on paper and/or tinder or the like cooking fuel ignition facilitation) that provides an improvement in the igniter technique featured in the fifth method of igniting charcoal described above. In an embodiment of the present invention the ignition facilitator assembly includes, in combination, a container positioned below a charcoal grate (or cooking fuel source support) and supported by a component of the grill as in a base component (e.g., cooking bowl) of a cooking receptacle. An embodiment of the cooking fuel ignition facilitator assembly comprises an aperture in the base receptacle of the grill, such as a central, lower aperture formed in the bottom of a kettle grill base or main body. Alternate embodiments of the invention include more peripheral positioning of the grill main body and associated cooking fuel ignition facilitator; although a central positioning works well in some embodiments such as the noted kettle grill type. Above the aperture formed in the main body of the grill is positioned a cooking fuel support as in a charcoal support rack extending above the lower aperture in the base receptacle of the grill but generally within the lower region of that base receptacle (e.g. the lower third portion of the base receptacle).

The cooking fuel ignition facilitator assembly further includes, in an embodiment, a collar extending down below the bottom region of the base receptacle and having a central axis that extends through the lower aperture in the base receptacle and also through the plane defined by the cooking fuel support. The collar features flow ports as in a series of apertures spaced about the circumference or periphery of the collar. An embodiment also includes the added feature of flow adjustment means relative to the flow ports in the collar as in a collar assembly with a first base or fixed ring and a second, sliding ring (or two sliding rings with at suitable collar support) with each ring having apertures designed to either (at least partially) align to provide air flow ports or become non-aligned as to have a portion of the sliding or adjusting ring close or essentially close off the flow ports. A collar flow adjustment handle is featured in the embodiment with the sliding ring as to enable the above described adjustment between the closed and open states of the collar flow means.

The cooking fuel ignition assembly further comprises an ignition facilitator combination (or tinder source positioning assembly) that comprise a supported receptacle (e.g., a removable container). In an embodiment an ash receptacle is provided that is designed for tool-less removal from the bottom region of the grill base receptacle as in a sliding male/female (e.g., bracket-catch flange) relationship. The ash receptacle is configured as to have an opening in an upper area as in one that is at least partially aligned with the collar opening above as well as the lower aperture formed in the bottom of the grill.

The ash receptacle further includes a side wall (e.g., a cylindrical side wall or a polygonal cross-sectioned side wall) having a handle that is sized for full hand grasping by the operator for facilitating on/off positioning of the ash receptacle relative to the grill base receptacle (as well as movement external to the grill base receptacle). In an embodiment the handle has a grasping section as well as upper and lower extensions that extend, respectively, to an upper rim region and a lower rim region of the ash receptacle side wall (e.g., within 20 percent of the respective upper and lowest most rim edges of the ash receptacle). The ash receptacle has a closed or generally closed off bottom end (opposite the opened upper end of the ash receptacle). This provides a coffee mug configuration in the ash receptacle, although various other configurations are featured under the invention including multi-handled embodiments.

The ash can receptacle and collar assembly also preferably include, as at an upper rim region of the ash can receptacle and a lower region of the collar, retention means for releasable retention of the ash can receptacle in an ignition operation position below the flow aperture formed in the bottom of the base grill receptacle. In an embodiment, the retention means includes a pair of flange projections diametrically opposed and extending radially out from the upper rim region of the ash receptacle. The flange projections (or male support extensions) are designed for sliding insertion within a corresponding pair of U-shaped flange brackets (or female support receptors) that are diametrically opposed on opposite sides of the collar such that the flange projections can be simultaneously slid along the respective groove tracks defined by the U-shaped flange brackets. A suitable stop is provided in an embodiment of the above described retention means as in a full stop member such as a closed off end of the slide track and/or a cam like offset in the slide track which provides a clamp retention force relative to the asserted flange projection of the ash can receptacle or a pin contact stop is provided as the stopping means. Also, although the above describes the ash can receptacle having the male support extension, a reverse relationship is featured in an alternate embodiment (e.g., the collar having the male extension projection and the ash can receptacle the female support receptor or a hybrid combination with one type on one side of the ash can receptacle and the opposite on the other side).

An embodiment also features the collar flow ports in a region above the level of the catch relationship between the ash can receptacle and the collar such that there is a stacked relationship with the base grill receptacle at the top, the collar (as in the collar flow ports) in an intermediate position and the ash can receptacle at the lower end of the stack with or without a degree of telescopic overlap for each interface. In an embodiment the collar flow ports are in an intermediate region relative to the height of the collar.

The cooking fuel ignition facilitator assembly further includes an ignition facilitator combination or tinder source positioning assembly which includes a tinder support device as in a tinder support stand that is received within the confines of the ash can receptacle. In an embodiment the tinder support device comprises an upper region tinder support platform as in tinder support rack or grid with a tinder contact portion separated by openings. In an embodiment the support platform comprises a plurality of inter-connected bars with a peripharl bar wrap. An embodiment has the upper region of the tinder support with a planar upper support surface (e.g., a horizontal plane comes in contact with a plurality of tinder support contacts without any significant tinder support members rising above that plane (with or without added reception recesses below that plane).

The tinder support device further includes a lower spacer structure as in a leg assembly that extends down from the level of the tinder support platform to a lower contact end such as with the bottom of the ash can receptacle or another region of the ash can receptacle (e.g., spring bars that extend radially outward as in catch regions on the interior surface of the ash receptacle side wall). An embodiment includes a plurality of vertically extending bars that are similar in configuration as that forming the grid or lattice structure providing the tinder support platform. An example includes four support rods or bars that provide four support legs that extend down from the platform as to have their free ends contact the upper surface of the bottom wall or bottom wall region of the ash can receptacle. An alternate embodiment includes an ash can receptacle having an internal peripheral configuration that allows for reception contact and retention, at a desired height level, of the tinder support platform having a coordinated catching peripheral edge configuration. For example, an inward flange, axial projecting members or tapering side wall is provided in the interior of the ash can to support at a desired level the tinder support device. In this embodiment, the tinder support device can have legs, or reliance can be placed on the catch relationship alone. In a further embodiment, the tinder support is integrated with the ash can, as by way (though not limited to) a permanent attachment (e.g., a weld), a screw fastening or other integration means. With this embodiment, the ash can preferably includes an access opening at a lower height, as in an access hatch, with or without a releasable hatch cover.

An embodiment of the tinder support stand includes one featuring the upper platform formed by a plurality of spaced apart bars that are joined at their respective ends to a peripheral connecting ring which is preferably joined to an under surface of the respective upper positioned bar set. In an embodiment, a first and a second one of the bars of the parallel set (as in those positioned to opposite ends of the support platform) have leg extensions off from each connecting point region as in a monolithic U-shaped bar with the base portion of the U-shaped bar providing a bar on the support platform and the extensions defining the support legs for the support platform. Also the peripheral wrapping ring preferably extends at the under side of the border region of the base and legs for the U-shaped members to provide for support contact in the upper set of bars. In an embodiment the parallel bars all fall on a common horizontal plane to define a horizontal tinder support platform. Also, in an embodiment the remaining platform bars are free of leg extensions in having the focus of their function on tinder support only.

The upper set of bars (e.g., a parallel set of bars) is preferably spaced as to avoid tinder fall through prior to burning and ash fall through after burning. For instance, in an embodiment directed at paper as the tinder, the spacing is designed to prevent a rolled up piece of paper (e.g., an 8½×11 inch page) or newspaper sheet from falling through the spacing between the upper support rods (until the burning period is over in which case the ashes can fall readily down into the base of the ash can receptacle). Thus a plurality of crumpled up paper sheets (e.g., 3 to 8 as in 6) can be supported on the tinder support platform for purposes of ignition. The upper opening of the ash receptacle (and preferably the entire length in one embodiment) is preferably about 3 to 7 inches in diameter (or equivalent amount of area if not circular) and preferably within 20% (plus or minus) relative to the area represented by the grill main body base aperture. The upper area defined by the tinder support platform is at (slight friction contact) or more preferably a bit smaller in area (e.g., within 20%) of that represented by the ash receptacle opening. An example of a suitable dimension for an embodiment is 5.5 inches or about 135 mm for the above noted upper opening for the ash can receptacle with a vertical height of, for example, 5.75 inches or about 146.5 mm.

The support platform is an embodiment that is preferably designed to have a peripheral edge that allows for ready insertion (and removal) of the tinder support into (and out of) the open end and confinement region of the ash can receptacle. In an embodiment there is provided a radial spacing all around such that there is avoided frictional contact when the vertical central axes of the ash can receptacle and the support platform are commensurate. The peripheral spacing is, for example, similar or less than the above noted bar spacing which avoids tinder drop through, at least prior to tinder ignition.

Alternate embodiments feature different tinder preferences as in wood chips and the like in which case the support platform can be designed to accommodate the tinder preference as in a less spaced support bar arrangement to accommodate wood chips or the like (e.g., a wire mesh) that may have a smaller area than occupied by a crumpled up piece of paper.

Also, an embodiment features a support platform having a peripheral concave recess extending inward which is aligned with the handle region of the ash container. The concave recess extends radially inward from the peripheral region of the tinder support platform, and thus accommodates an extension of the handle fastening means as in a bolt or the like while providing large tinder support area coverage relative to the ash can opening.

The support platform preferably defines a tinder support level in the upper half of the ash can receptacle as in the upper third or quarter height of the ash can receptacle (e.g., 25% plus or minus 5%). Also, the relative relationship between the collar assembly and the ash can receptacle and tinder support device includes an arrangement where the support platform is at a level that provides for the tinder to be at the level or higher than a plane extending through the central region of at least one of the collar flow ports. Also, in an embodiment, the collar flow ports are of a size that provides for a wooden match or other lighting means to extend through the port and into contact with the radially inward positioned and supported on the platform tinder. For example, the support platform is of a height within the ash can receptacle such that a horizontal line extending through a flow port (illustrative of a stick match extension) extends into contact with the tinder (or enables lighting with a stick match or the like within the noted extension direction). Alternate embodiments feature a relationship wherein the above noted light extension line extends at an acute angle relative to the horizontal in a plus and minus direction as in at or within plus or minus 15° or at or within plus or minus 5°, with that angle providing for tinder contact within the first half section of the area of the platform on the same side as the flow port being used.

In use of the cooking fuel ignition assembly, an operator can remove the tinder support combination by sliding it out. If used previously the tinder support stand can be removed and the ashes dumped or otherwise cleaned out. The operator inserts the tinder support stand within the ash can receptacle such that lower spacer structure makes contact with the receiving portion (e.g., base) of the ash can receptacle and the upper platform is in the upper region of the ash can receptacle (e.g., around the upper 25% of the ash can height). The operator then places tinder on the upper surface (e.g., one or more rolled up paper sheets with or without alternate types of tinder). The placement of the tinder on the support platform is preferably done prior to the complete insertion of the ash can receptacle on the collar, although in alternate embodiments there can be inserted the tinder after the tinder support positioning assembly is fully inserted as by removing the fuel support grid and inserting the tinder down through the apertures provided at the base of the grill receptacle and the collar and upper opening in the ash can receptacle. Embodiments include the insertion of ignition facilitator combination (or tinder source positioning assembly) to complete the ignition facilitator assembly after the tinder has been supplied by sliding it into position relative to the grill base receptacle. Alternatively, there can be provided a space or support platform access area in which the tinder can be supported while the cooking fuel support remains in position but prior to cooking fuel support. Alternatively, depending on the tinder type (e.g., bark slivers and/or saw dust and/or leaves etc.) the tinder can be dropped or pushed through the grates of the cooking fuel support or simply passed through an access gate or the like in the cooking fuel support device.

Either before or after positioning of the ignition facilitator combination in ignition position, the fuel support grid is provided as well as a suitable cooking fuel on the fuel support grid as in the placement of a charcoal support rack within the grill base receptacle and charcoal thereon as in a pyramid stack arrangement aligned with the aperture formed at the bottom of the grill base receptacle.

The fuel ignition procedure can be implemented with the insertion of a suitable lighter (e.g., a wooden long match or a gas (e.g., propane) lighter or a metal heating rod) through the flow ports in the collar and into ignition contact with the tinder supported on the tinder support platform. Once the tinder is ignited there is initiated a flame spread to the supplied cooking fuel with the flow porting in the collar providing air injection and the positioning of the tinder on the support platform provides for heat generation and flame positioning which facilitates the ignition of the cooking fuel in a rapid and highly ensured ignition maintenance fashion. Also an embodiment has the relative positioning of the ash can receptacle, tinder support platform and collar, designed for air injection in a generally horizontal fashion into the base region of the tinder flame, which air (and flame) flow then travels up through the collar opening and grill base aperture and preferably into direct contact with the cooking fuel positioned on the fuel support rack directly above. An embodiment features the flames generated in the ignition facilitator assembly extending up and past the cooking fuel with a standard amount of tinder supplied and without flame enhance liquid. Alternate tinder platform height or tinder type embodiments feature the average height flame length end below but sufficiently close to the fuel supply as to create sufficient heat build up to achieve ignition, although for many embodiments the direct flame contact during essentially the full period of tinder burn before tinder ash dropping through the support platform is preferable.

### BRIEF DESCRIPTION OF THE DRAWINGS

FIG. 1 shows a perspective, exploded view of a cooking apparatus embodiment of the invention.

FIG. 2 shows a top perspective view of the cooking apparatus of FIG. 1 in an assembled state with the lid removed.

FIG. 3 shows a front elevational view of the cooking apparatus of FIG. 2.

FIG. 4 shows a top plan view of the cooking apparatus of FIG. 2.

FIG. 5 shows a top plan view of the cooking apparatus of FIG. 1 in an assembled state.

FIG. 6 shows a partially cut-away, cross-sectional view taken along cross-section line I-I of FIG. 5.

FIG. 6A shows an exploded view of the grill base receptacle and collar assembly alone.

FIG. 7 shows the cooking apparatus of FIG. 1 in an assembled state with a cooking fuel ignition facilitator combination in a partially removed slide support state and being free of tinder.

FIG. 8 shows an enlarged view of a portion of FIG. 7 in the region of the cooking fuel ignition facilitator assembly.

FIG. 9 shows a top plan view of the cooking fuel ignition combination.

FIG. 9A shows a view similar to FIG. 9 but with tinder (paper in this instance) in position.

FIG. 9B shows an exploded view of the grasp handle, fasteners, and ash receptacle main body alone.

FIG. 10 shows a cross-sectional view taken along cross-section line II-II of FIG. 5.

FIG. 11 shows a perspective view of a tinder support device or tinder support stand of the present invention.

FIG. 12 shows a top plan view of the stand of FIG. 11.

FIG. 13 shows a front elevational view of that shown in FIG. 12.

FIG. 14 shows a rear elevational view of that shown in FIG. 12.

FIG. 15 shows a left side elevational of that which is shown in FIG. 12.

FIG. 16 shows a right side elevational of that which is shown in FIG. 12.

FIG. 17 shows a bottom plan view of the support stand.

FIG. 18 shows the ignition facilitator device with tinder in a partial insertion or reception state relative to the support region of the grill base or grill receptacle's main body.

FIG. 19 shows the ignition facilitator assembly in operation igniting cooking fuel charcoal briquettes.

FIG. 20 shows an alternate “table top” embodiment of a cooking apparatus suited for use with the tinder support device of the present invention.

### DETAILED DESCRIPTION

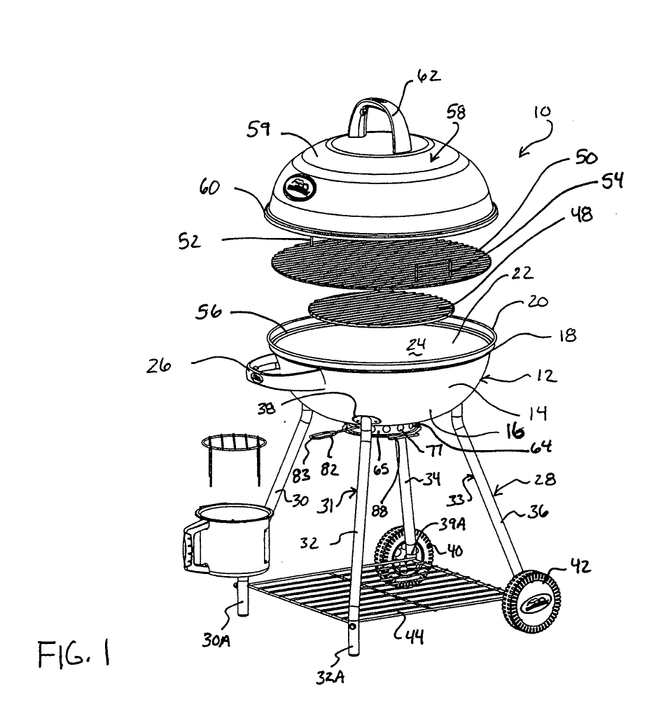

FIG. 1 illustrates cooking apparatus 10 in an exploded view and in the form of a barbeque kettle grill, although a variety of other grill types are featured under the present invention including, for example, cylindrical (horizontally or vertically oriented) and polygonal shaped main body configurations. Receptacle 12 includes exterior surface 14 which, for this kettle grill embodiment, features a hemi-spherical configuration. Grill receptacle 12 includes bottom region 16 and upper peripheral edge region 18 with free edge rim 20 defining the upper end of interior cavity 22 defined by interior surface 24.

Cooking apparatus 10 further includes base handle 26 secured to exterior surface 14 of grill receptacle 12 as well as leg support structure 28. In the embodiment shown, leg support structure 28 comprises legs 30, 32, 34, 36 with legs 30, 32 forming forward (relative to operator's positioning) leg pair set 31 and legs 34 and 36 forming rear positioned leg pair set 33. Each of legs 30, 32, 34 and 36 have an upper attachment end which in this embodiment includes a plurality of flanged attachment structures 38 designed for securement to grill main body 12. Alternate leg support structures or main grill body support means are featured under the present invention including, for example, tripod assemblies, a hollow pedestal leg support (e.g., with an ash can receptacle access door or opening), etc. The front leg pair set 31 featured in the embodiment shown includes opposite free ends 30A and 32A designed for direct contact with the ground support. The rear pair set 33 of legs includes roller wheels 40, 42 supported at the lower end regions 39A and 39B of respective rear legs 34, 36. Handle 26 is also shown as being diametrically opposite the set of roller wheels 40, 42 to facilitate operator repositioning of the grill 10.

FIG. 1 further illustrates lower support rack 44, which in this embodiment includes a rectangular configured metallic grid with corner regions designed for securement to the lower end regions of the four aforementioned legs. Support rack 44 provides a convenient storage location as for grilling equipment or other items desired for storage during grill use.

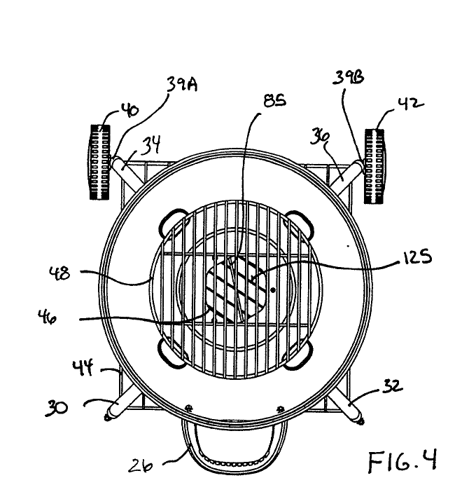

As shown in FIGS. 1, 2, 4 and 6A, bottom region 16 of receptacle 12 includes aperture 46 which is shown having a hexagonal configuration and as being centered in the bottom region of the grill receptacle 12 and opening into interior cavity 22 extending thereabove. In a lower or base region (e.g., at or within the lower ½ or ⅓ of the height of the grill receptacle 12) of interior cavity 22 there is positioned fuel support grid or grate 48 which is supported as to be in a horizontal orientation when in its operational position. Food support grid 50 (FIG. 1) is positioned above fuel support grid 48 (and is also shown as being in a horizontal position as well as in a parallel orientation position relative to fuel support grid 48). Food support grid 50 is in an upper region of receptacle 12 (e.g., upper ½ or ⅓ of the receptacle 12 height as in within the uppermost region as within the 10% percent upper height region or essentially right at the upper edge (0%) as shown). Food support grid 50 is also shown with grid grasping handles 52 and 54. Food support grid 50 is configured to rest in supporting fashion on catch flange ring 56 formed in the upper peripheral edge region. In FIG. 4 only fuel support grid 48 (e.g., a charcoal rack with parallel spaced bars and a peripheral wrap bar and a pair of intermediate underlying support bars) is shown and not food support grid 50 to better visualize the relationship between aperture 46 at the base of receptacle 12 and the overlying fuel support grid 48.

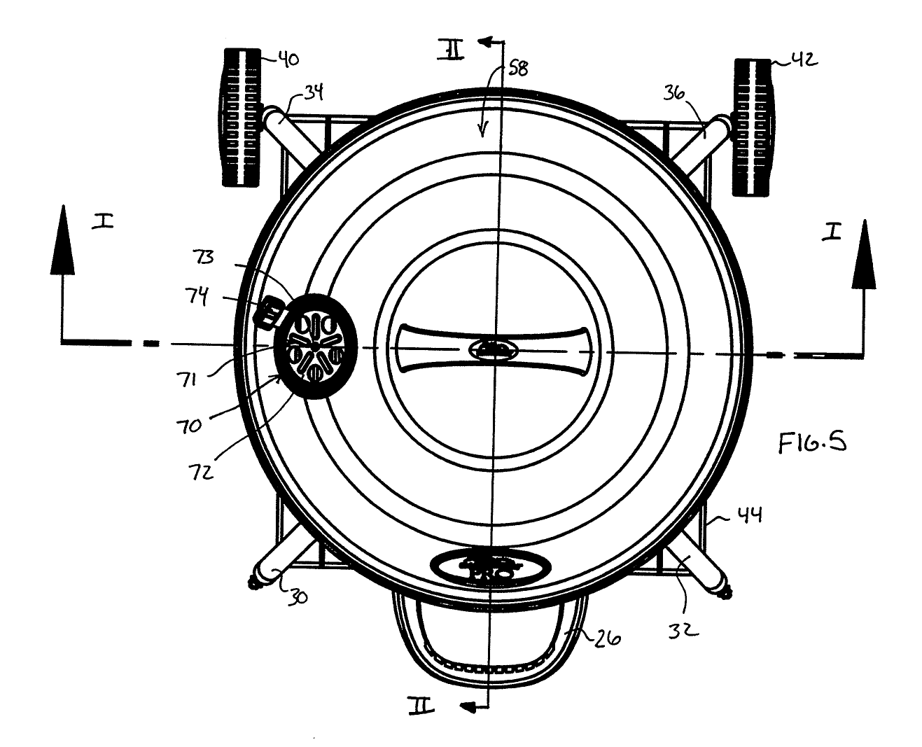

As shown in FIGS. 1 and 5, lid 58 includes peripheral flanged edge 60 which is configured to rest on free edge rim 20. Lid 58 further includes lid handle 62. Lid handle 62 is shown as being at the top, central region of lid main body 59 featured in the illustrated hemi-spherical cover or lid 58 of the kettle grill embodiment illustrated.

As shown in 5, lid 58 further includes lid flow aperture adjustment means 70 which in this embodiment comprises an apertured region in lid main body 59 with pivotable louver plate assembly 71 having apertured cover plate 72, pivot post 73, and louver handle 74. Thus, by adjustment of handle 74, there can be adjusted the amount of flow access through the lid by louver flow state adjustment from an essentially closed to an essentially or completely open lid aperture porting state.

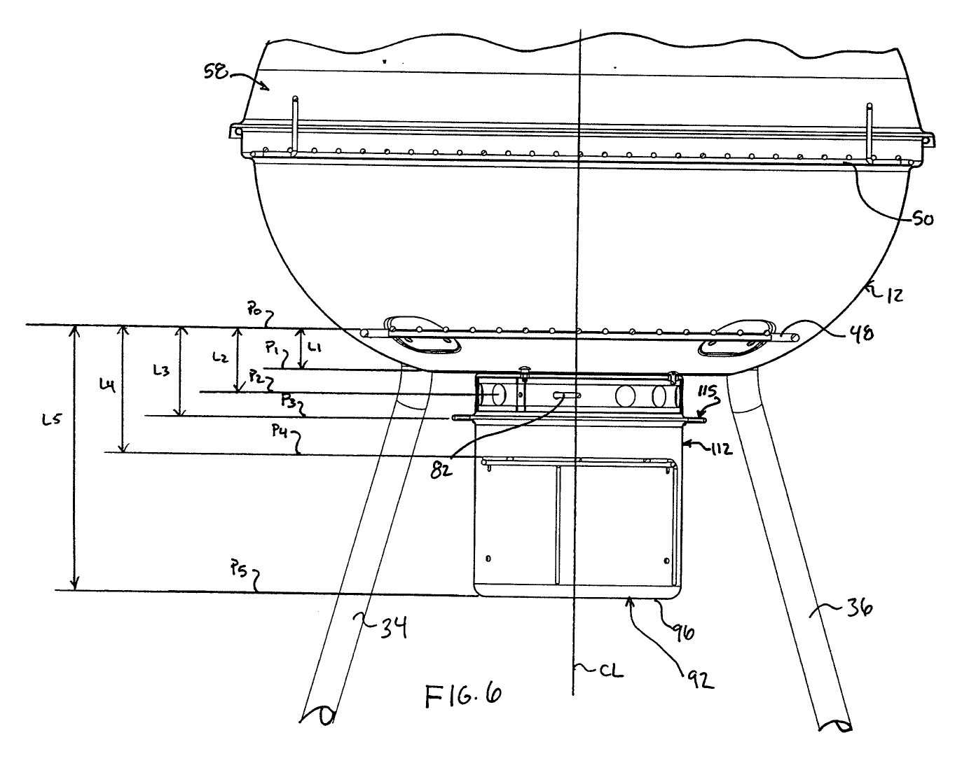

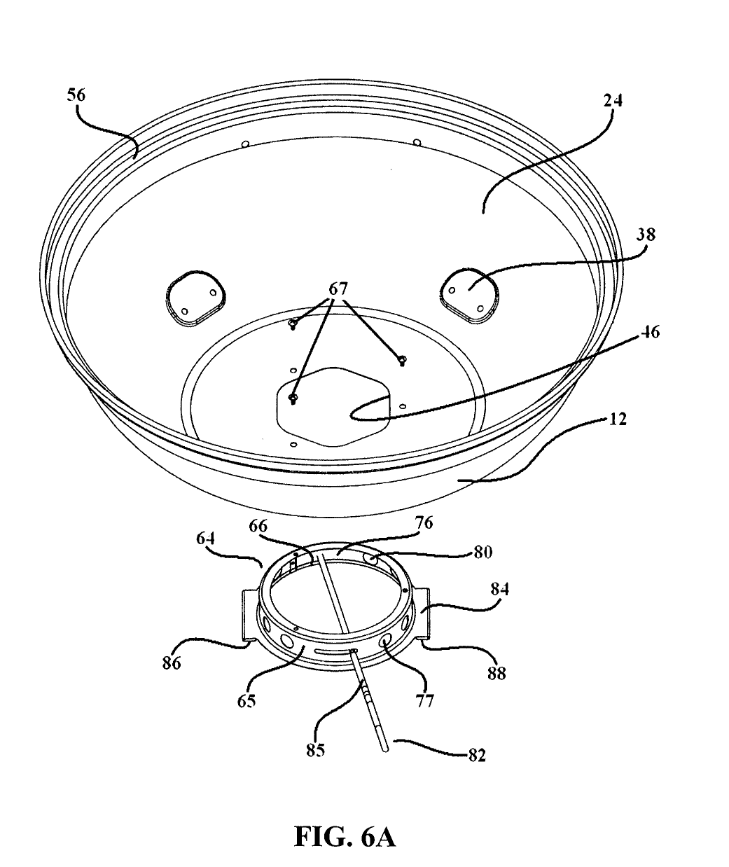

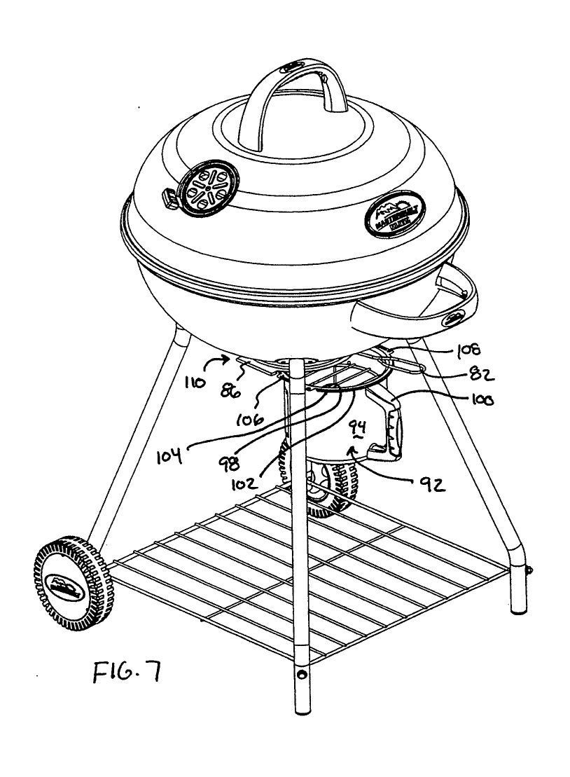

Suspended below bottom region 16 of main body 12 and bordering aperture 46 is collar or in this embodiment collar assembly 64 (with “collar” being generic to a single or integrated non-adjustable unit (e.g., fixed fluid flow aperture embodiment) collar extension as well as the collar assembly described herein with flow adjustment means) which has a base ring 65 that is preferably fixedly secured to main body 12 (e.g., a tool based attachment as the securement as in a bolt or screw fastener attachment or a more permanent attachment as in a weld or rivet functioning as the securement means). In this regard, reference is made to FIG. 6A wherein there is shown collar (collar assembly in this embodiment) 64 and grill main body 12 in exploded view together with fasteners 67 designed to extend through holes formed in a border region of grill main body 12 which extends about aperture 46. Fasteners 67 extend into a receiving area in collar assembly 64 such that collar assembly 64 and grill main body 12 can be fastened together. In alternate embodiments a more permanent securement is featured as in a weld relationship is provided. As shown in FIG. 6A, base ring 65 is shown in this embodiment as having a cylindrical shaped interior surface 66 extending down and out away from receptacle main body 14. The illustrated cylindrical shaped base ring 65 provides a slide support for adjustable, second ring 76 which is slidingly received in a channel defined in interior surface 66. Base ring 65 includes collar flow port holes 77 that are circumferentially spaced apart, and second ring 76 also has a plurality of port apertures 80 (FIG. 6A) that are circumferentially spaced apart.

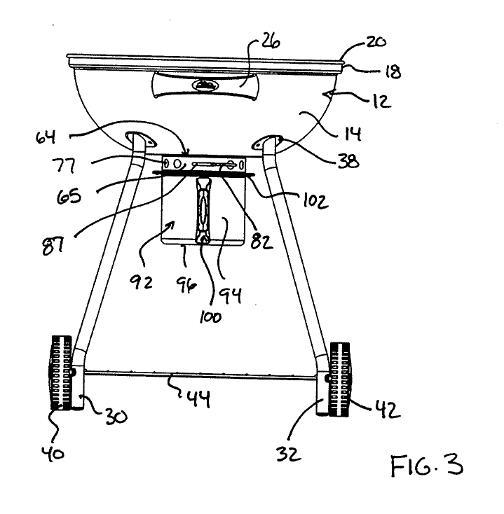

Collar assembly 64 further includes adjustment handle 82 which adjusts second ring 76 relative to first ring 65 to provide for inlet port adjustment relative to collar assembly 64. In this embodiment, adjustment handle 82 is formed of a single bent bar having a looped grasping end 83 and an extension bar 85 designed for securement at its free end to adjustable second ring 76 such that rotation of handle 82 within elongated slot 87 (FIG. 3) formed in base ring 65 creates movement in interior second ring 76 such that the apertures on second ring 76 are either more aligned with the apertures in base ring 65 to create higher level air flow access or less aligned as to lessen or limit or essentially block/discontinue air flow through base ring 65. The air flow is adjusted in conjunction to provide a suitable length and heat level relative to the provided tinder positioning dictated by the below described tinder support.

As shown in FIGS. 6A and 8, base collar ring 65 includes first catch device 84 which in this embodiment comprises female capture flanges 86 and 88 diametrically opposed along a diametric line extending midway through the collar periphery such as in a mid region between the first and second leg pair sets 31 and 33. Capture flanges 86 and 88 represent female reception flange brackets that extend radially out farther than lower end collar flange 90 of first capture device 84. Collar flange 90 is shown extending essentially about the full-periphery of base ring 65. Female flange projectors 86 and 88 feature opposing U-shaped brackets that have interior rail surfaces that define slide surfaces. Female flange projectors 86 and 88 are thus shown to each define a linear slide channel within an extended U-shaped channel.

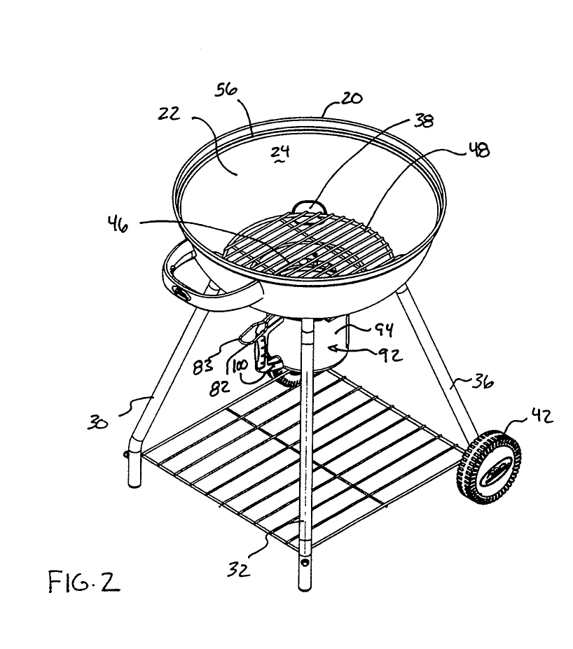

FIGS. 1 to 3 and 8 illustrate ash receptacle or ash can 92 shown as having side wall 94 (cylindrically configured in the illustrated embodiment) with closed bottom 96 and open top 98. The side wall is also shown to be closed with no apertures in this embodiment as well such that the upper opening is the air access region relative to the ash can receptacle. In alternate embodiments a suitable hatch or the like can be added to facilitate ash dumping. Container 92 further includes ash can handle 100 as well as contact flange 102 shown in this embodiment extending about the periphery of the upper edge 104 of side wall 94. Contact flange 102 is provided with diametrically opposed, radially extending male projection extensions 106 and 108 that are sliding received and supported by opposing capture flanges 86 and 88. As shown in FIG. 2, can handle 100 is preferably aligned relative to a bisecting vertical plane with adjustment handle 82 of collar assembly 64 when in one of its open and closed adjustment states (e.g., a vertical plane bisecting the grill midway between the roller wheels as represented by the FIG. 10 cross-section), and that plane is preferably 90 degrees offset relative to a bisecting vertical plane extending through the sliding bracket catch assembly of the present invention.

An embodiment of the invention features ignition facilitator assembly or means 110 (e.g., one that is based on paper and/or tinder or the like cooking fuel ignition facilitation) that provides an improvement in the grill ignition technique. Ignition facilitator assembly 110 includes, in combination, the aforementioned ash can container 92 shown, when in an operating state, positioned below charcoal grate 48 or cooking fuel source support. The cooking fuel ignition facilitator assembly 110 further comprises aperture 46 formed in the base receptacle of the grill, such as the above described central, lower aperture formed in the bottom of a kettle grill base or main body 12.

Cooking fuel ignition facilitator assembly 110 further includes collar 64 (shown as a collar assembly in this embodiment with added flow port adjustment means) extending down below the bottom region of the base receptacle and having central axis CL (FIG. 6) that extends through the lower aperture 46 in the base receptacle 12 and also perpendicularly through the plane defined by the cooking fuel support 48. The above described collar flow air adjustment means (adjustment handle 82 and the associated sliding ring combination (65, 76) is also provided in an embodiment of the facilitator assembly 110 with respective staggered or aligned flow apertures (77, 80) depending on relative positioning) provides for adjustments in air flow with a middle to full open flow state typically utilized for operation of the present ignition facilitator assembly 110 although lower settings as in a partially blocked (e.g., medium flow level or below) may be desirable in some ignition settings (e.g., high wind conditions).

Cooking fuel ignition assembly 110 further comprises ignition facilitator combination (or tinder source positioning assembly) 112 that comprises the below-described tinder support device 124 and ash receptacle 92 (e.g., ash can) that is designed for tool-less removal from the bottom region of the grill base receptacle as in the above described sliding bracket-catch flange relationship as well as the below described tinder support platform. The ash receptacle 92 is configured as to have its upper end opening 98 at least partially aligned (e.g., common central axis with the CL extension) with the collar ring opening positioned above as well as the lower aperture 46 formed in the bottom of the grill positioned even farther above as seen by the CL extension through the central region of each as shown in FIG. 6.

In an illustrative embodiment, the illustrated ash receptacle 92 has its side wall 94 (e.g., a cylindrical side wall or a polygonal cross-sectioned side wall) of a vertical length sufficient to receive a full hand grasp sized handle such as handle 100 which is sized for full one hand grasping by the operator for facilitating stable on/off positioning of the ash receptacle relative to the grill base receptacle (as well as movement external to the grill base receptacle). As shown in FIG. 8, handle 100 has hand grasping section 114 as well as upper and lower extensions 116 and 118. Upper and lower extensions 116, 118 extend, respectively, to upper rim region 104 and lower rim region 105 of the ash receptacle side wall 94 (e.g., within 20% of the respective upper and lowest most rim edges of the ash receptacle). This provides a coffee mug configuration in the ash receptacle 92, although various other configurations are featured under the invention including multi-handled embodiments.

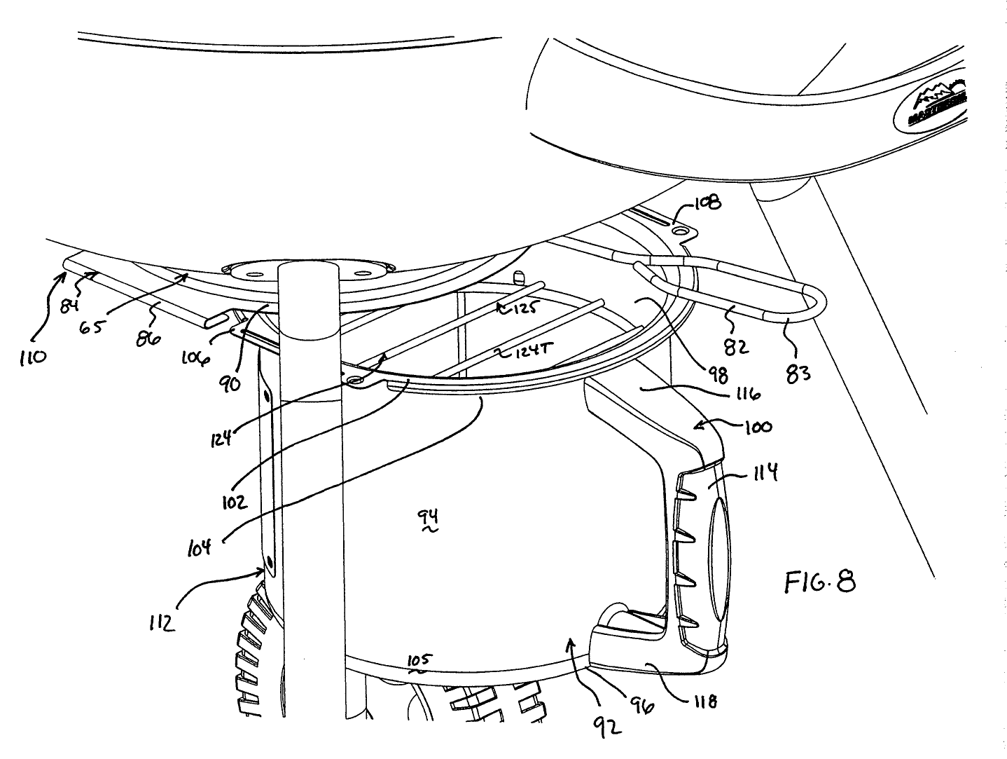

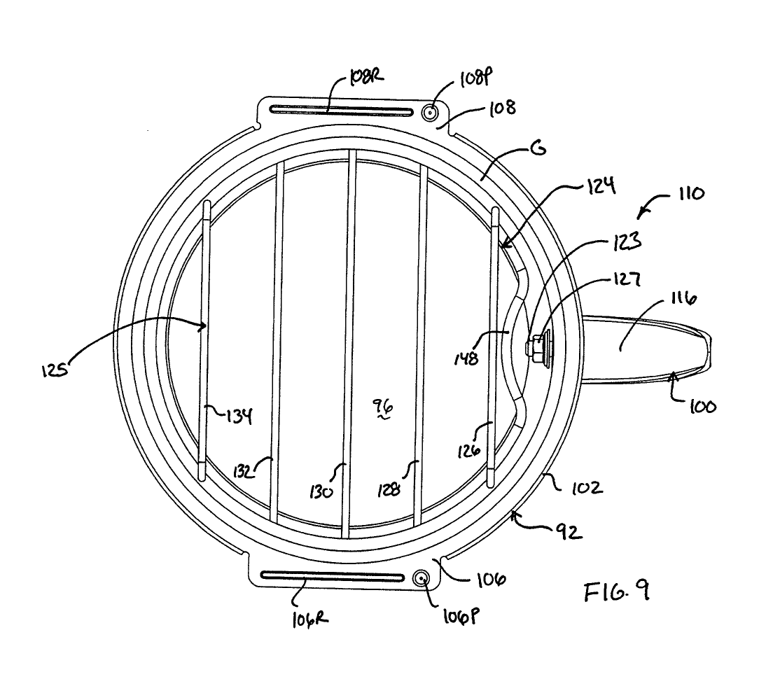

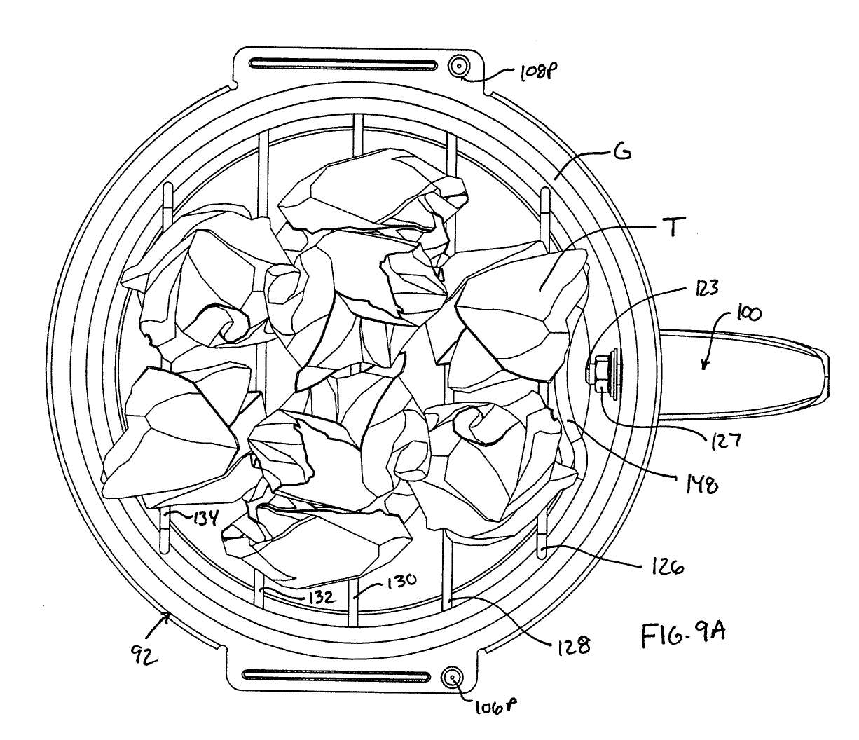

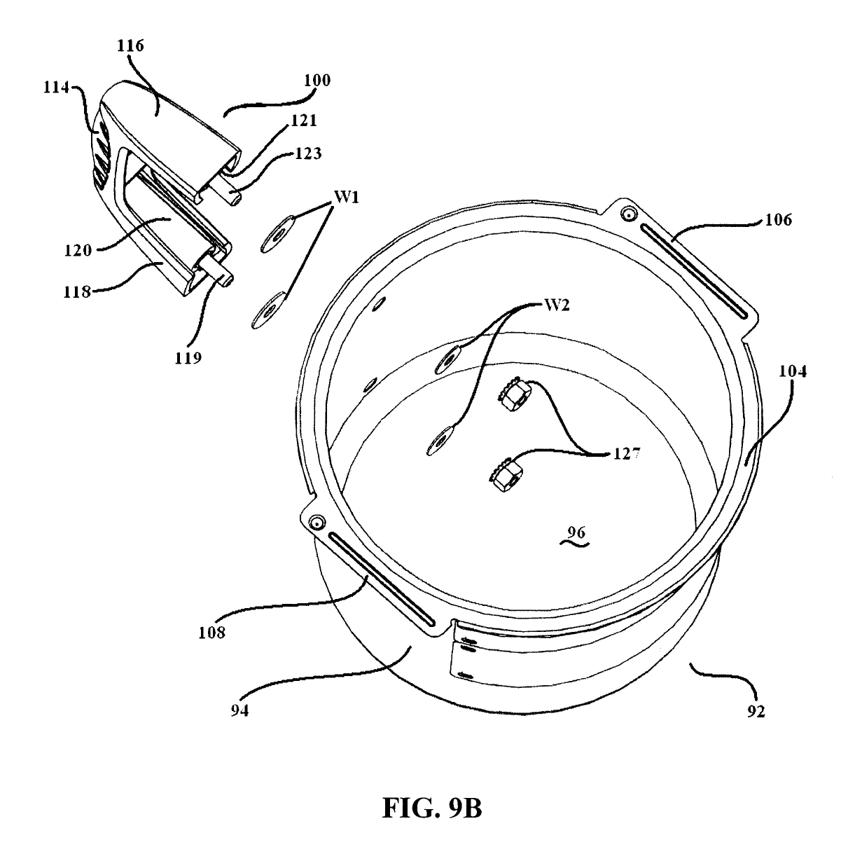

As shown in FIG. 8 handle 100 is secured to the main body of ash receptacle (represented by side wall 94) by way of fasteners or alternate securement means with FIG. 8 illustrating a lower, formed cylindrical fastener casing 120 hidden from view for the most part by lower extension 118. As further seen in FIG. 9B, a similar arrangement is provided relative to upper extension 116 with the fastener casing 121. Extending within the cylindrical fastner casings are securement members (e.g., embedded bolts) 123 and 119 each extending through an interior/exterior washer pair combination W1, W2, and holes formed in side wall 94 of container 92 and each securement member is shown in this embodiment with nut 127 attached at a free end.

The ash can receptacle and collar also preferably include, as at an upper rim region of the ash can receptacle and a lower region of the collar, retention means 115 (FIG. 6) for releasable retention of the ash can receptacle in an ignition operation position below the flow aperture 46 formed in the bottom of the base grill receptacle 12. In an embodiment, the retention means includes the above-described pair of flange projections 106 and 108 diametrically opposed and extending radially out from the upper rim region 104 of the ash receptacle. The flange projections (or male support extensions 106) are designed for sliding insertion within the corresponding pair of U-shaped flange brackets 86, 88 (or female support receptors) that are diametrically opposed on opposite sides of the collar such that the flange projections can be simultaneously slid along the respective groove tracks defined by the U-shaped flange brackets and form part of the retention means 115. A suitable slide stopping means is provided in an embodiment of the above described retention means as in a full stop member such as a closed off end of the slide track and/or a cam like offset in the slide track which provides a clamp retention force relative to the asserted flange projection of the ash can receptacle or pin projections such as pins 106P and 108P described below. Also, although the above describes the ash can receptacle having the male support extension, a reverse relationship is featured under an alternate embodiment (e.g., the collar having the male extension projection and the ash can receptacle the female support receptor or a hybrid combination with one type on one side of the ash can receptacle and the opposite on the other side).

An embodiment also features the collar flow ports 77, 80 positioned in a region above the level of the catch relationship provided by retention means 115 between the ash can receptacle and the collar such that there is a stacked relationship with the base grill receptacle 12 at the top, the collar 64 (as in the collar flow ports) in an intermediate position and the ash can receptacle 92 at the lower end of the stack with or without a degree of telescopic overlap for each engagement.

The ignition facilitator assembly further comprises tinder support device 124 as in a tinder support stand that is received within the confines of the ash can receptacle 92 and has an upper end 124T (FIG. 8) lying below the upper rim edge of the ash receptacle 92. In an embodiment the tinder support device 124 comprises an upper region tinder support platform 125 as in a tinder support rack or grid with a tinder contact portion separated by openings and, in this embodiment, being planar, although non-planar open gaped embodiments are also features as in individual pocket or an egg-grate bent bar arrangement (not shown) to further secure tinder positioning during can 92 movement. As shown in FIGS. 9 and 12, for example, an embodiment has support platform 125 comprised of a plurality of inter-connected tinder support bars 126, 128, 130, 132 and 134 with a peripharl bar wrap 136 being joined to opposite end portions of the respective bars. Rather than planar wires across the top, staggered or coinciding sinusoidal bars are featured in an alternate embodiment to provide recesses for tinder reception as in an egg-crate design.

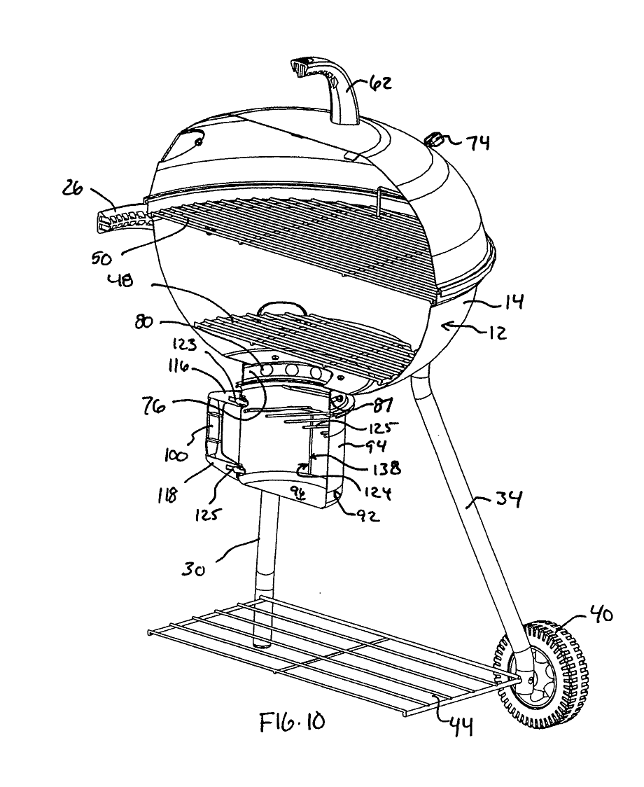

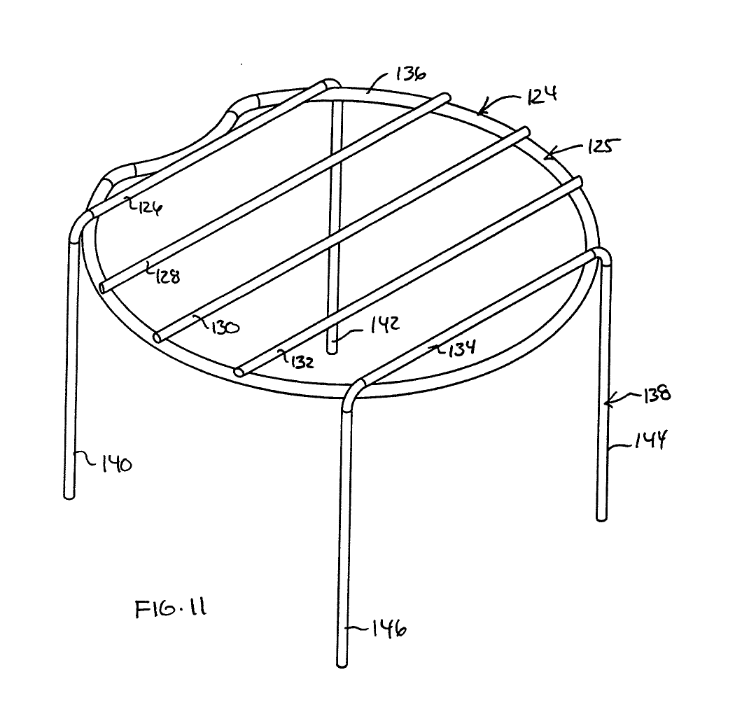

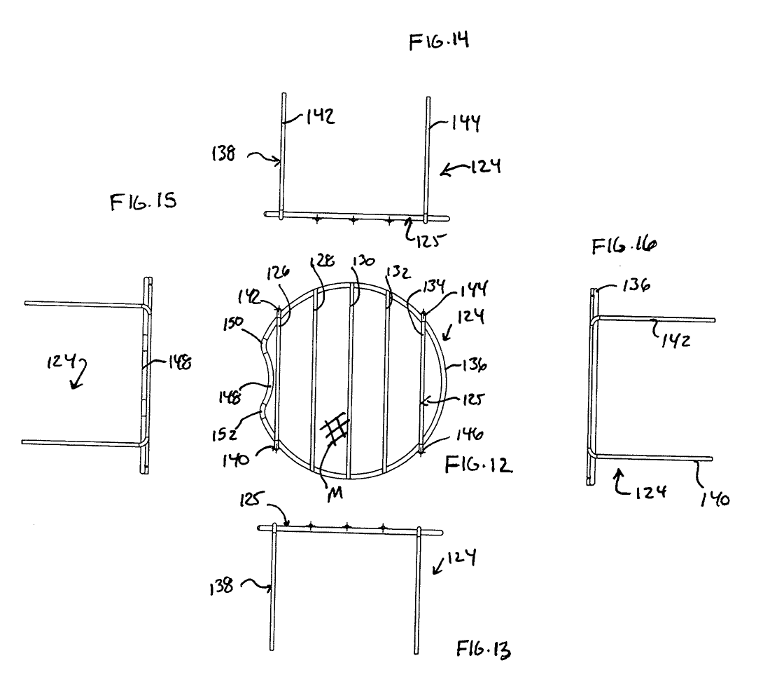

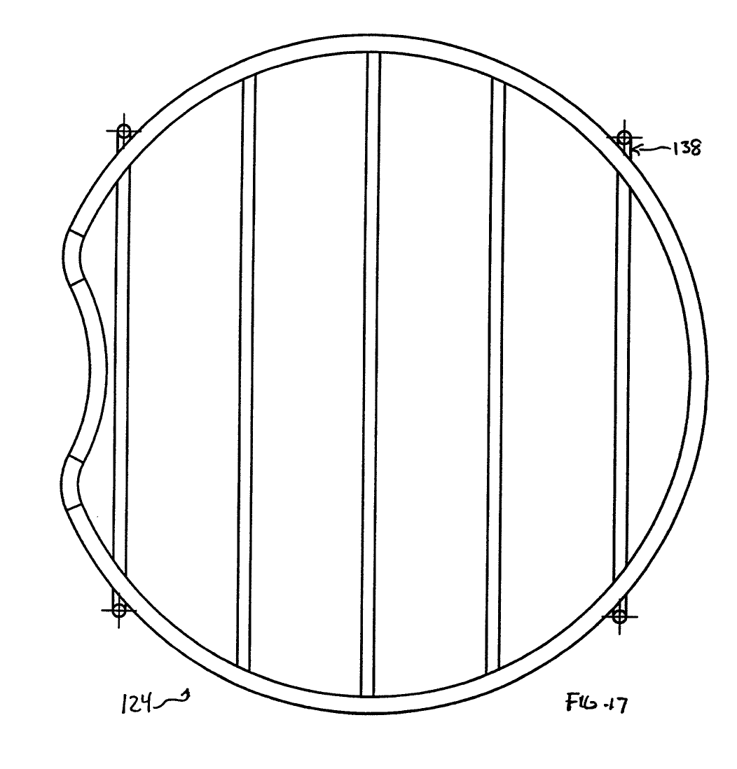

As show in FIGS. 11-17, an embodiment of the tinder support device 124 further includes a lower spacer structure 138 as in a leg assembly that extends down from the level of the tinder support platform to a lower contact end such as with the bottom of the ash can receptacle or a lower region of the ash can receptacle (e.g., in an alternate embodiment (not shown) spring bars extend down and radially outward as in catch recessed regions on the interior surface of the ash receptacle side wall or a helical spring like coil single bar is featured in similar fashion to a bed-spring (with added, upper support platform). As best shown in FIG. 11, the illustrated embodiment includes a plurality of vertically extending bars which form platform legs 140, 142, 144, 146. In the illustrated embodiment all of the bars are preferably similar in material and cross-sectional size 140, 142, 144, 146 are shown as extending down from the platform 125 as to have their free ends suited for contact the upper surface of the bottom wall 96 of the ash can receptacle 92.

An embodiment of the tinder support stand 124 includes upper platform 125 formed by a plurality of the spaced apart bars 126, 128, 130, 132 and 134 that are joined as by a weld or bond connection to the peripheral connecting ring 136 which is preferably joined to an under surface portion of the spaced apart bars 126, 128, 130, 132 and 134. Bars 126, 128, 130, 132 and 134 in the embodiment are shown to include a set of linear bars or bar sections. The interior bars 128, 130 and 132 are shown as extending parallel with a gap between respective centers of the bars. With a cylindrical ash can 92 featured in this embodiment, support platform 125 preferably has a generally commensurate circular configuration to conform to a circular cross-sectional configuration in the ash can 92 upper region. Thus linear lengths include an intermediate longest length bar 130 having a length conforming to the diameter of the peripheral, generally circular connecting ring 136. The adjacentmost bars 128 and 132 to opposite sides of central bar 130 thus have an intermediate length relative to the shorter horizontal length exteriormost bars 126 and 134. Exteriormost bars 126 and 134 within the parallel set of bars forming the support platform 134 are however, shown in this embodiment as also being positioned to opposite ends of the support platform and as having integral leg extensions (e.g., a monolithic U-shaped bar) extending off from each connecting point region with connecting ring 136 so as to provide the aforementioned legs 140, 142, 144 and 146. Also, as shown the base portion of the U-shaped bars 126 and 134 each represent one of the linear tinder support platform bars while the U-shaped bar leg extensions define the support legs for the support platform.

Also, the peripheral wrapping ring 136 preferably extends at the under side of the border region of the base and legs for the U-shaped members to provide for level support contact in the full set of parallel bars shown. The interior, remaining bars 128, 130 and 132 are shown free of leg extensions. The upper set of bars (e.g., a parallel set of bars) is preferably spaced as to avoid tinder fall through prior to significant burn. For instance, in an embodiment directed at paper as the tinder, the spacing is designed to prevent a rolled up piece of paper (e.g., an 8½×11 inch page) or newspaper sheet from falling through the spacing between the upper support rods (until, for example, the burning period is over in which case the ashes can fall readily down into the base of the ash can receptacle). Thus a plurality of crumpled up paper sheets (e.g., 3 to 8 as in 6) can be supported on the tinder support platform for purposes of ignition. A suitable gap width relative to a line extending perpendicularly between the central length of extension lines of the bars is of, for example, length of 10 mm to 50 mm (e.g., the sub range of 20 mm to 40 mm being well suited for paper tinder support). A distance illustrative of an embodiment of the invention includes one suited for having an average adult sized finger set reach in with some clearance and grasp to liftout (or put back) the tinder support 124 from the ash can following cooling (as for ash can cleaning).

The support platform 125 is shown in FIG. 9 as having a peripheral edge defined by peripheral ring 136 of a size that allows for ready insertion (and removal) into (and out of) the open end and confinement region of the ash can receptacle 92. In an embodiment there is provided radial spacing all around as shown by gap G in FIG. 9 which extends the full circumference between the interior of the ash can 92 and the exterior of peripheral ring 136 such that there is avoided frictional contact when the vertical central axes of the ash can receptacle and the support platform are commensurate. The peripheral spacing is, for example, similar or less than the above noted bar spacing which avoids tinder drop through, at least prior to tinder ignition (e.g., a gap G length of from 0 inches (slight friction contact with side can) to a ¼ inch or 5 mm of gap space).

FIGS. 9 and 9A illustrate male projection extensions 106 and 108 designed for sliding reception in the supporting, respective capture flange brackets 86 and 88. Male projection extensions 106 and 108 are shown as each comprising an elongated ridge (106R and 108R) which increases the vertical height of extensions 106 and 108 as to provide a friction slide contact within the confines of capture flange brackets 86 and 88. Also, there is shown posts 106P and 108P which provide suitable slide stops relative to the brackets by extending in height higher than the upper level of brackets 86 and 88.

Alternate embodiments feature different tinder preferences as in wood chips and the like in which case the support platform can be designed to accommodate the tinder preference as in a less spaced support bar arrangement to accommodate wood chips or the like that may have a smaller area than occupied by a crumpled up piece of paper (e.g., wire mesh as shown schematically as M in FIG. 12 either alone or above (e.g., welded) bars 126 to 134).

Also, an embodiment features a support platform 125 having concave recess section 148 extending radial inward (as in more than ½ way past the maximum diametrical length gap between the peripheral ring extension and adjacentmost bar 126 which gap is similar to the above described finger insertion platform bar spacing at its maximum). With a preferred continuous bar defining peripheral ring 136, the recessed section 148 is formed by bending inward at bar regions 150 and 152. As further seen in FIG. 9, the concave recess extends radially inward from the peripheral region of the tinder support platform 125, an amount sufficient to accommodate (e.g., provide for sliding there past without obstruction) an extension of the handle fastening means as in the nut 127 and free end of bolt 123 shown in FIG. 9. In an alternate embodiment, support platform 125 can have a peripheral compression bias feature (e.g., an outer periphery collapsing arrangement with a spring out function) to achieve insertion and a catch relationship internally within the ash can 92. With such an arrangement, tinder support device 124 can have legs, or be free of legs.

The support platform 125 preferably defines a tinder support level in the upper half of the ash can receptacle as in the upper ⅓ or upper ¼ height of the ash can receptacle. Also, the relative relationship between the collar assembly 64 and the ash can receptacle 92 and tinder support device 124 includes an arrangement where the support platform is at a level that provides for the top of the tinder to be close to the flow port level in height (e.g., the support platform being within 1 to 4 inches of the plane defined by the flow ports in the intermediate region of the collar and more preferably less than 3 inches as in about 2.5 inches) including placement of the upper surface of the tinder at the same level, just below or higher than a plane extending through the central region of at least one of the collar flow ports 77 (80). An illustration of such a relationship is seen in FIGS. 6, 10 and 18.

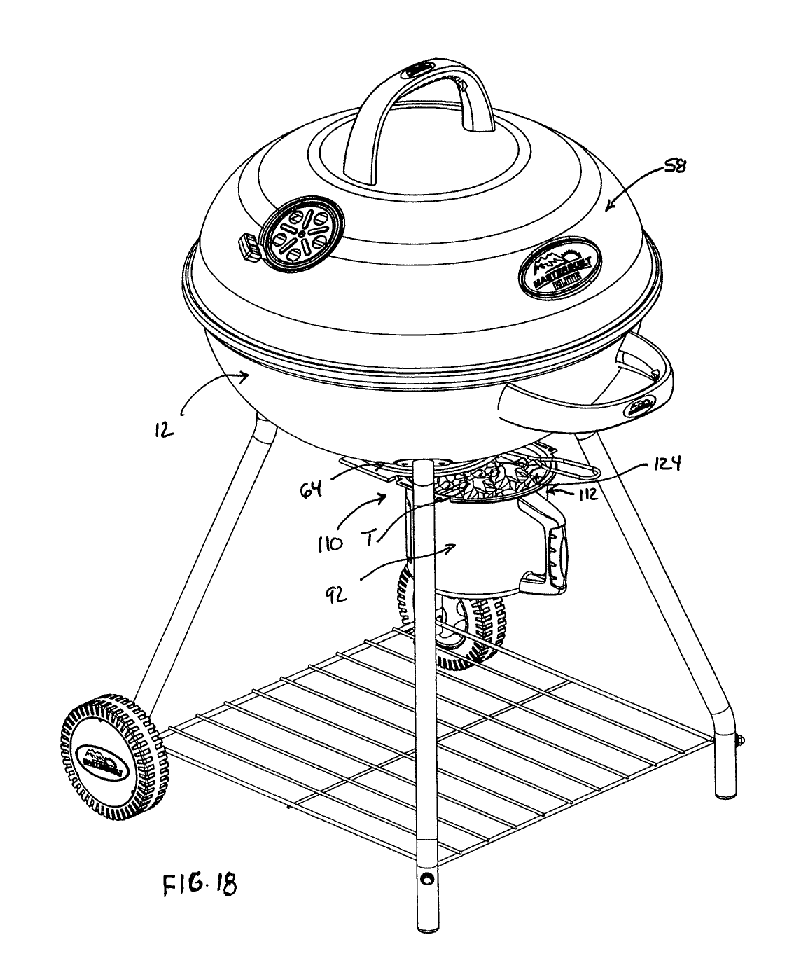

As shown in FIG. 6, starting with the upper surface of fuel support surface 48 as the origination plane PO, the level of aperture 46 (which is essentially at the interface level between the upper edge of collar 64 and the lower contact edge of base receptacle 12 (which is shown as having a flattened section in this region)) falls on plane P1 and is represented by length L1 down from plane PO. In an embodiment the interfacing between collar assembly 64 and the bottom of receptacle 12 is achieved by providing an upper flanged rim in collar main body or base ring 65 with suitable fasteners spaced therearound and extending through a border region of base receptacle 12 which surrounds aperture 46. Also, the central region of collar flow port holes 77 is shown as falling at plane P2 which is at a length L2 below the origination plane P0. The interface region of the retention means 115 between the sliding contact surfaces of male extension projections 106 and 108 with respective brackets 86 and 88 (which generally conform to the lower edge of collar assembly 64 and the upper edge of ash receptacle 92) is shown on plane P3 which is at length L3 down from the origination plane P0. There is further illustrated the tinder support surface plane P4 for tinder support platform 125 which is at a length L4 below the origination plane. Also, while the depth of the receptacle 92 is variable to some extent, there is illustrated plane P5 for the bottom of ash receptacle 92 which is at length L5 below the origination plane P1. Also, with reference to FIG. 18 there is seen tinder T in position on tinder support platform 125 which tinder has an upper surface portion that is generally close to (within ½ to 3 inches for example) or at the level of P3 and also includes arrangements wherein the tinder extends up into the confines of the collar region (e.g., between planes P3 and P2) Provided below are some examples (not intended to be limiting) of some length ranges featured for each of L1 to L5. FIG. 6 also illustrates each of planes Po to P5 extending in parallel fashion.

| | General | Example range within | Illustrative value(s) |
|---|---|---|---|
| Ref. | illustrative range | general illustrative range | within ranges |
| L1 | 20 to 50 mm | 30 to 40 mm | 35 mm |
| | | | (+/−1 to 3 mm) |
| L2 | 38 to 68 mm | 48 to 58 mm | 53 mm |
| | | | (+/−1 to 3 mm) |
| L3 | 58 to 88 mm | 68 to 78 mm | 73.25 mm |
| | | | (+/−1 to 3 mm) |
| L4 | 96 to 126 mm | 105 to 117 mm | 111.25 mm |
| | | | (+/−1 to 3 mm) |
| L5 | 140 to 280 mm | 190 to 260 mm | 218.75 mm |
| | | | (+/−1 to 3 mm) |

Thus, as seen from the values above the distance from P0 to P1 (about 35 mm) is about the same as the sum of the respective distances from P1 to P2 and P2 to P3 which are about the same (e.g., the values are within 10% to 25% of each other in illustrative embodiments) (as in the 18 and 20 mm values featured above), which sum is in turn is about the same as the distance between P3 to P4 (e.g., the values are within 10% to 25% of each other in illustrative embodiments as in the 39 mm distance being about equal to the sum of 18 and 20 mm distances noted above). Also, the distance from P0 to P4 is about equal to P4 to P5 (e.g., the tinder platform level being about 111 mm with the depth of the can below being about 108 mm) such that the can depth below tinder platform plane P4 is the greatest spacing between adjacent planes within the above described plane set of P0 to P5. Also, in the illustrated embodiment the collar vent ports 77 are about equally spaced within the height of the column such that plane P2 falls about ½ way between planes P1 and P4. Thus, in an embodiment the level of the interface of the collar and aperture of the grill base is about equal to the depth of the collar below that interface of the collar and the grill base with the flow ports preferably provided in a central height region of the collar. The tinder support is preferably within two to five inches of the noted aperture 46 level or interface between the collar and the grill main body (e.g., 3 inch +/−1 inch depth) and preferably the distance from top of the can to the tinder support platform is 0.5 to 3 inches as in a 1.5 inch depth down from the open top edge of the ash receptacle 92. A 2 to 3 inch spacing between plane P2 at the center of a flow port 77 in the collar and the tinder support platform level (e.g., a 2.5 inch depth) is illustrative of some embodiments of the invention.

Also, in an embodiment, when the collar flow ports 77, 80 of the respective first and second collar rings 65, 76 are completely or sufficiently aligned (e.g., when the flow apertures of the respective first and second rings are adequately aligned), there is provided one or more openings that provide lighting access means, which opening is of a size that preferably provides for a wooden match or other lighting means to extend through the port and into contact with the radially inward positioned tinder T which is supported on the tinder platform 125. For example, the support platform 125 is of a height within the ash can receptacle 92 such that a horizontal line extending through a flow port (illustrative of a stick match extension) extends into contact with the tinder T (or enables lighting of the tinder with a stick match or the like within the noted extension direction due to the close proximity of the tinder T to the match head or lighting source or “lighting proximity”). Alternate embodiments feature a relationship wherein the above noted light extension line extends at an acute angle relative to the horizontal in a plus and minus direction as in at or within plus or minus 15° or at or within plus and minus 5°, with that angle providing for tinder contact (or lighting proximity) within the first half section of the area of the platform on the same side as the flow port being used.

To use the ignition facilitator assembly 110, an operator inserts the tinder support device 124 within the ash can receptacle 92 such that its support region 138 (e.g., tinder support bars 140, 142, 144 and 146) makes contact with the ash can. The operator then positions the desired tinder T (e.g., one or more rolled up paper sheets with or without alternate types of tinder) on the upper surface of the platform 125. The insertion of tinder is preferably done prior to the complete insertion of the ash can receptacle on the collar 64 (e.g., a sufficient crumpling to enable the paper if used to slide past the collar (e.g., as in the 1.5 inch depth of the tinder support platform described above with some typical paper compression expansion occurring after insertion as in another inch or less to place the tinder upper surface in good contact relationship relative to the access flow ports such as 77) In alternate embodiments there can be inserted the tinder after the tinder support positioning assembly 112 is fully inserted as by removing the fuel support grid 48 and inserting the tinder down through the aperture 46 provided at the base of the grill receptacle and the collar opening and upper opening in the ash can receptacle.

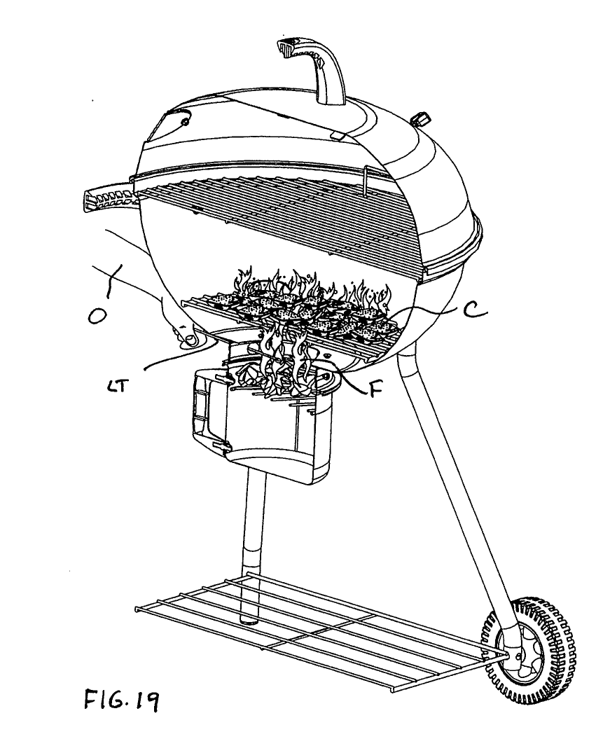

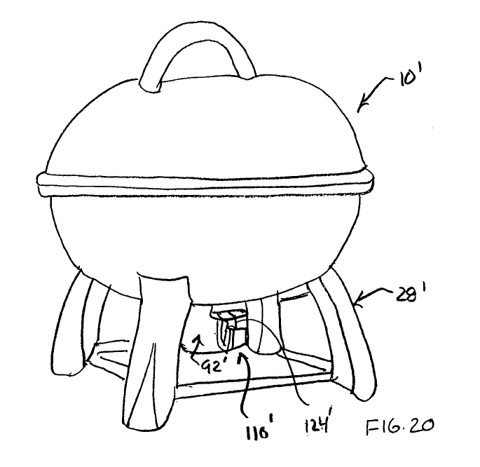

FIG. 18 illustrates the initial slide in insertion step taken to position a tinder loaded ignition facilitator combination 112. As seen an operator O (FIG. 19) can readily grasp handle 100 and insert the ignition facilitator combination in place by sliding it within the capture flange brackets or capture means (86, 88) associated with collar assembly 64.

Either before or after positioning of the ignition facilitator combination 112 in ignition position, the fuel support grid 48 is provided with a suitable cooking fuel as in the placement of a charcoal support rack within the grill base receptacle and placement of charcoal thereon. The charcoal is typically placed in a pyramid or multi-level stack arrangement that is aligned with the aperture 46 formed at the bottom of the grill base receptacle.

As shown in FIG. 19, the fuel ignition procedure can be implemented by having the operator O insert suitable lighter LT (e.g., a wooden long (or even a shorter) match or a gas (e.g., propane) lighter or a metal heating rod) though the sufficiently aligned flow ports 77 and 80 in the collar assembly 64 and into ignition contact with the tinder T supported on the tinder support platform 125.

FIG. 19 also shows an ignition state or ignition initiation state wherein the tinder T has been ignited and there is initiated a flame spread to the supplied cooking fuel (e.g., charcoal or hardwood briquettes) with the flow porting in the collar assembly providing air injection and the positioning of the tinder on the support platform provides for heat generation and flame positioning which facilitates the ignition of the cooking fuel in a rapid and highly ensured ignition maintenance fashion. At this point of flame spread the operator is likely to have earlier removed the lighter LT but is shown still in position in FIG. 18 for explanation purposes. Also an embodiment has the relative positioning of the ash can receptacle 92, tinder support stand 124 and collar assembly 64, designed for air injection in a generally horizontal fashion into the base region of the tinder and/or tinder flame F generated by the tinder, which air (and flame) flow then travels up through the collar opening and grill base aperture 46 and into contact with the cooking fuel C positioned on the fuel support rack directly above. As further shown in FIG. 19, the flame F extending up from the tinder makes direct contact with the cooking fuel.

FIG. 20 shows an alternate table top cooking apparatus 10′ which shares common features of that depicted in cross-section in FIG. 19, but for the different non-roller and stubbier grill main body leg support structure 28′. Also, depending on the vertical separation length of the leg support structure, can receptacle 92′ forming part of the cooking fuel ignition assembly 110′ with tinder support 124′ can be made shorter than that shown in FIG. 19 and hence tinder support can be sized accordingly, to place the tinder in a position such as shown in FIG. 19 (e.g., within 3 inches or less of the flow porting level or lighting aperture if different).

The invention also features a method of using the above-described outdoor cooking apparatus for lighting cooking fuel to cooking operation temperature which includes igniting tinder supported by the tinder support platform positioned close to a top edge of the ash can with collar vent ports in an open state as to generate flame contact with the cooking fuel. A method of the invention also includes a method of assembling the above-described outdoor cooking apparatus which includes placement of the tinder support structure into a receptacle such as an ash can and suspending the tinder support combination below an aperture in the base of the grill body where an air flow aperture is formed. A suitable manner of suspending is sliding the tinder support combination onto a collar with reception means until the opening of the ash can is positioned below the base grill aperture whereby tinder placed on a supporting tinder platform of the tinder support structure is positioned at an upper region of the ash can receptacle and also into the collar region in some embodiments.

What is claimed is:

1. A cooking fuel ignition facilitator comprising:
a container having at least one side wall, with a lower platform and an opening arranged at opposite ends of the at least one side wall and defining a recess in the container;
a support platform positioned in the recess; and
at least one support member configured to position the support platform at a predetermined distance from the lower platform; wherein
the container is configured to be support by a cooking receptacle.

2. The cooking fuel ignition facilitator of claim 1, wherein
the container is configured to be removably connected to a bottom wall of the cooking receptacle.

3. The cooking fuel ignition facilitator of claim 1, wherein
the support platform is removably positioned in the recess of the container.

4. The cooking fuel ignition facilitator of claim 1, wherein
the support platform is positioned below an upper rim of the at least one side wall of the container.

5. The cooking fuel ignition facilitator of claim 1, wherein
the container further comprises a hatch, adapted to provide access to the recess in the container.

6. The cooking fuel ignition facilitator of claim 1, wherein
the container is configured to be connected to a cooking receptacle adapted for outdoor use.

7. A method of igniting cooking fuel, comprising:
placing a fuel ignition facilitating material on the support platform of the fuel ignition facilitator of claim 1;
igniting the fuel ignition facilitating material; and
igniting a fuel material with the fuel ignition facilitating material.

8. The method of cooking of claim 7, further comprising:
collecting waste products from at least one of the fuel ignition facilitating material, the fuel material and a food item cooked with the fuel material, on the lower platform of the fuel ignition facilitator.

9. The method of cooking of claim 7, further comprising:
before placing a fuel ignition facilitating material on the support platform, positioning the support platform in the recess of the container; and
after placing a fuel ignition facilitating material on the support platform, connecting the fuel ignition facilitator to a cooking receptacle having a fuel support platform and a food support platform.

10. A cooking apparatus comprising:
a cooking receptacle having at least one wall;
a fuel support platform and a food support platform supported on the at least one wall of the cooking receptacle; and
a fuel ignition facilitator, comprising:
a container having at least one side wall, with a lower platform and an opening arranged at opposite ends of the at least one side wall and defining a recess in the container;
a support platform positioned in the recess of the container; and
at least one support member configured to position the support platform at a predetermined distance from the lower platform of the container; wherein
the at least one wall of the cooking receptacle includes a bottom wall, and
the fuel ignition facilitator is connected to the bottom wall of the cooking receptacle.

11. The cooking apparatus of claim 10, wherein:
the support platform of the fuel ignition facilitator is positioned in a heat transfer arrangement with the fuel support platform of the cooking receptacle, and
the fuel support platform of the cooking receptacle is positioned in a heat transfer arrangement with the food support platform of the cooking receptacle.

12. The cooking apparatus of claim 10, further comprising:
an attachment unit connected to the bottom wall of the cooking receptacle; wherein
the fuel ignition facilitator is removably connected to the cooking receptacle by the attachment unit.

13. The cooking apparatus of claim 12, wherein:
the attachment unit comprises a plurality of apertures adapted to provide an air-flow to the support platform positioned in the recess of the fuel ignition facilitator, when the fuel ignition facilitator is connected to the attachment unit.

14. The cooking apparatus of claim 13, wherein:
the attachment unit further comprises a first surface and a second surface, the second surface being configured to be selectively moveable relative to the first surface;
the plurality of apertures of the attachment unit are positioned on the first and second surfaces, and
the second surface is selectively adjustable between at least a first position and a second position, wherein
in the first position, at least one aperture on each of the first and second surfaces are at least partially aligned as to enable an air flow to the support platform of the fuel ignition facilitator, and
in the second position, apertures on the first and second surfaces are not aligned and air flow through the apertures is prevented.

15. The cooking apparatus of claim 14, wherein:
the attachment unit is a collar, and the first and second surfaces are a pair of concentric rings.

16. The cooking apparatus of claim 12, wherein:
the attachment unit is removably connected to the bottom wall of the cooking receptacle.

17. The cooking apparatus of claim 10, wherein:
the cooking receptacle is adapted for outdoor use.

18. A method of igniting fuel, comprising:
placing a fuel ignition facilitating material on the support platform of the fuel ignition facilitator in the cooking apparatus of claim 10;
igniting the fuel ignition facilitating material; and
igniting a fuel material with the fuel ignition facilitating material.

19. The method of cooking of claim 18, further comprising:
collecting waste products from at least one of the fuel ignition facilitating material, the fuel material and a food item cooked with the cooking fuel, on the lower platform of the fuel ignition facilitator.

20. The method of cooking of claim 18, further comprising:
before placing a fuel ignition facilitating material on the support platform, positioning the support platform in the recess of the fuel ignition facilitator; and
after placing a fuel ignition facilitating material on the support platform, connecting the fuel ignition facilitator to a cooking receptacle having a fuel support platform and a food support platform.

21. The method of cooking of claim 18, wherein:
the fuel ignition facilitator is configured to be removably connected to a cooking receptacle by an attachment unit connected to the cooking receptacle, the attachment unit comprising a first surface and a second surface, the second surface being configured to be selectively moveable relative to the first surface between at least a first position and a second position, wherein
in the first position, at least one aperture on each of the first and second surfaces are at least partially aligned and enable an air flow to the support platform of the fuel ignition facilitator, when the fuel ignition facilitator is connected to the attachment unit, and
in the second position, apertures on the first and second surfaces are not aligned and air flow through the apertures is prevented; and
the method of cooking further comprises:
after placing a fuel ignition facilitating material on the support platform, removably connecting the fuel ignition facilitator to the cooking receptacle having the attachment unit; and
adjusting an air flow to the support platform in the fuel ignition facilitator by adjusting the position of the second surface of the attachment unit relative to the position of the first surface of the attachment unit.

22. A method of assembling a cooking apparatus, comprising:
connecting a fuel ignition facilitator to a bottom wall of a cooking receptacle; wherein
the fuel ignition facilitator comprises
a container having at least one side wall, with a lower platform and an opening arranged at opposite ends of the at least one side wall and defining a recess in the container;
a support platform positioned in the recess of the container; and
at least one support member configured to position the support platform at a predetermined distance from the lower platform of the container.

23. The method of assembling a cooking apparatus of claim 22, further comprising
removably positioning the support platform in the fuel ignition facilitator such that the support platform is, with respect to a height length of the receptacle, within the upper 33% of the receptacle.

24. The method of assembling a cooking apparatus of claim 22, wherein
connecting the fuel ignition facilitator to the cooking receptacle includes
connecting the fuel ignition facilitator adjacent to an opening in the bottom wall of the cooking receptacle, which opening is positioned below a fuel support platform and a food support platform positioned in the cooking receptacle.

25. The method of assembling a cooking apparatus of claim 24, wherein
connecting the fuel ignition facilitator to the cooking receptacle includes
connecting an attachment unit to the bottom wall of the cooking receptacle; and
removably connecting the fuel ignition facilitator to the attachment unit.
